(19) United States
(12) Patent Application Publication
(10) Pub. No.: US 2020/0123036 A1
(43) Pub. Date: Apr. 23, 2020

(54) ACTIVE CARBON AND MICROORGANISM COUPLING DEVICE FOR REMOVING PESTICIDE OUT OF FARMLAND DRAINAGE WATER

(71) Applicant: HOHAI UNIVERSITY, Jiangsu (CN)

(72) Inventors: Juan CHEN, Jiangsu (CN); Peifang WANG, Jiangsu (CN); Chao WANG, Jiangsu (CN); Jin QIAN, Jiangsu (CN); Han GAO, Jiangsu (CN)

(21) Appl. No.: 16/319,988

(22) PCT Filed: Oct. 17, 2017
(86) PCT No.: PCT/CN2017/106493

§ 371 Date: Jan. 23, 2019

(30) Foreign Application Priority Data
Jul. 13, 2017 (CN) 201710570481.3

(51) Int. Cl. C02F 3/34; C02F 1/28

(52) U.S. Cl. CPC C02F 3/34; C02F 2305/06; C02F 2203/006; C02F 1/281

(57) ABSTRACT

Provided is a device with microorganism-coupled activated carbon for removing agricultural chemicals in farmland drainage water, comprising a water-permeable mounting chute means (1), a coarse grid intercepting mesh (8), an insertable filter wall (3) and fixing piles (4); wherein the water-permeable mounting chute means (1) is provided with a slot (2) and a narrow groove (9), is closed at the bottom and the two sides parallel to the length direction of a farmland drainage ditch by a bottom baffle (10) and side baffles (5), respectively, and the water-permeable mounting chute means (1) is fixed to the farmland drainage ditch by the fixing piles (4); the insertable filter wall (3) is inserted into the slot (2); and the coarse grid intercepting mesh (8) is inserted into the narrow groove (9). The device has the advantages of small occupied space, high efficiency of agricultural chemical removal, thorough purification of the water body layer by layer, no influence on the drainage capacity of the ditch, convenient replacement and cyclic utilization, simple production, low implementation cost and ease of maintenance and management when being installed in the farmland drainage ditch.

### CROSS REFERENCE TO RELATED APPLICATION

This application is a 371 of International Application No. PCT/CN2017/106493 filed on Oct. 17, 2017 and claims priority to Chinese Patent Application No. 201710570481.3, entitled A DEVICE WITH MICROORGANISM-COUPLED ACTIVATED CARBON FOR REMOVING AGRICULTURAL CHEMICALS IN FARMLAND DRAINAGE WATER as filed on Jul. 13, 2017, which are incorporated herein by reference for all purposes.

### FIELD OF THE INVENTION

The disclosure relates to a device with microorganism-coupled activated carbon for removing agricultural chemicals in farmland drainage water, and pertains to the technical field of non-pointed source pollution control of agricultural chemicals in farmland.

### BACKGROUND OF THE INVENTION

With the transformation of agricultural management manner and the development of precision agriculture and intensive agriculture in recent years, the use of agricultural chemicals in the world has increased significantly, which imparts an important effect on control of crop pests and diseases, increase of crop yield, and improvement of quality of agricultural products. During the application of agricultural chemicals in farmland, only 10˜30% of the agricultural chemicals are effectively utilized, and more than 70% of the agricultural chemicals remain in the soil or float in the atmosphere, and enter the water environment through routes such as farmland drainage water after irrigation, rainfall, leaching, which seriously threatens water ecological security and human health. Farmland drainage water is the main way to output agricultural chemical pollution in farmland. Efficient removal of residues of agricultural chemicals in farmland drainage water is thus a key measure to control non-pointed source pollution of agricultural chemicals in agriculture, and is of great significance for quality improvement of water environment and water ecological security.

The farmland ecosystem contains abundant resources of agricultural chemical-degrading microorganisms, which can completely mineralize or degrade agricultural chemicals into non-toxic components. Microbial remediation is considered to be the most potential route for removal of agricultural chemical pollution because of its advantages of non-toxicity and high efficiency, no secondary pollution, high efficiency and low cost, and wide application. In essence, the existing technologies for controlling agricultural chemicals in farmland water body, such as constructed wetland technology, coastal buffer zone control technology, and ecological ditch purification technology, achieve the goal of purifying water body by in-situ interception of pollutants followed by microbial degradation. However, these technologies have disadvantages such as large occupied space, much infrastructure construction, high implementation costs, and difficult management, and therefore it is difficult to promote and apply these technologies on a large scale. In addition, the microorganisms that act in these technologies are not strains that achieve specific and efficient degradation of agricultural chemicals, and have low degradation efficiency, and thus it is difficult for these microorganisms to effectively remove agricultural chemicals in a short time period.

At present, the degrading strains which have high-efficiency degradation effects on various agricultural chemicals have been obtained by domestication and screening in the farmland system, and the development of microbial immobilization technology has promoted the application of these degrading strains in in-situ pollution remediation. Activated carbon has porous and strong adsorption properties, with a porous structure providing a habitat for the growth of degrading bacteria and being beneficial to the adsorption and immobilization of degrading bacteria on its surface. For example, Patent Application No. 201110351867.8 discloses a method of treating wastewater comprising organophosphorus agricultural chemicals by using immobilized microorganisms, comprising adsorbing domesticated fungus Aspergillus niger onto activated carbon of 5-8 mm in diameter prior to putting it into the wastewater comprising organophosphorus agricultural chemicals. After standing for 7 days, the degradation rate reaches 98%. Although the Patent application provides high degradation efficiency, activated carbon particles bearing non-indigenous degrading bacteria cannot be applied directly in farmland drainage water to remove agricultural chemical pollution, and there are drawbacks such as difficulty in recovery and secondary pollution of exogenous bacteria. Therefore, it is urgent to develop a device that is suitable for the environment of farmland drainage, requires no or less infrastructure construction, has convenient on-site installation, low cost, high efficiency of agricultural chemical removal, and convenient recovery and cyclic utilization for multiple times of immobilized particles.

### SUMMARY OF THE INVENTION

The disclosure provides a device with microorganism-coupled activated carbon for removing agricultural chemicals in farmland drainage water, with the purpose of solving the problem of non-pointed source pollution of agricultural chemicals in farmland. A water-permeable mounting chute means is fixed to the farmland drainage ditch and insertable filter walls are installed in the water-permeable mounting chute means. When the farmland water body flows through the insertable filter walls layer by layer, agricultural chemicals in the water body are adsorbed and degraded by the degrading bacteria-coupled activated carbon carrier, thereby reducing the concentration of the agricultural chemicals in the farmland drainage water.

Provided is a technical solution of the disclosure: a device with microorganism-coupled activated carbon for removing agricultural chemicals in farmland drainage water, comprising: a water-permeable mounting chute means 1, a coarse grid intercepting mesh 8, an insertable filter wall 3 and fixing piles 4; the water-permeable mounting chute means 1 is provided with a slot 2 and a narrow groove 9, is closed at the bottom and the two surfaces parallel to the length direction of the farmland ditch by a bottom baffle 10 and side baffles 5, respectively, and is fixed to the farmland drainage ditch 18 by the fixing piles 4; the insertable filter wall 3 is inserted in the slot 2; and the coarse grid intercepting mesh 8 is inserted into the narrow groove 9.

The invention possesses the following advantages:

1) the water-permeable mounting chute means is directly installed in the farmland drainage ditch, which involves few infrastructural work and no problem of occupied space;

2) when the farmland drainage water flows through many layers of the insertable filter walls, the agricultural chemicals in the water body are adsorbed and degraded by the microorganism-coupled activated carbon carrier, achieving a high efficiency of agricultural chemical removal, and thereby allowing the water body to be thoroughly purified layer by layer;

3) the multi-slot design of the water-permeable mounting chute means can be used to flexibly adjust the number and interval of the insertable filter walls; in the case that the drainage water amount is large during the rain or flood period, the insertable filter walls can be removed or the inserted number of the insertable filter walls can be reduced, in order to avoid blocking the ditch, without affecting inherent drainage capacity of the ditch;

4) the open-type design at the top of the insertable filter walls facilitates the regeneration and recycling of the degrading bacteria-coupled activated carbon carrier; and

5) the production is simple, the cost for implementation is low, it is easy for maintenance and management, and it is suitable for promotion and application on a large scale.

### BRIEF DESCRIPTION OF THE DRAWINGS

FIG. 1 is a perspective view of the invention.

FIG. 2 is a cross-sectional view of the invention.

FIG. 3 is a top view of the invention.

FIG. 4 is a perspective view of the insertable filter wall of the invention.

FIG. 5 is a schematic view of the arrangement of the invention in a farmland drainage ditch.

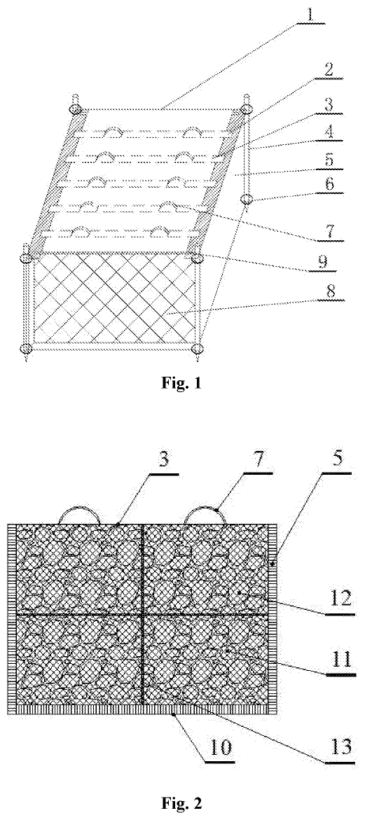

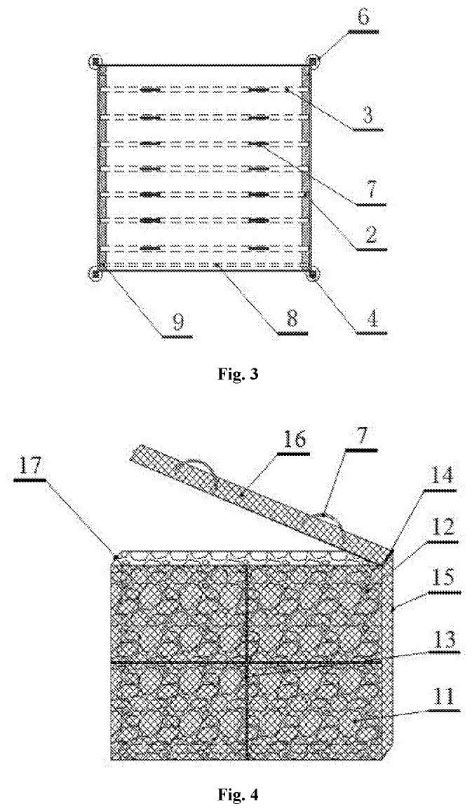

In the drawings, 1 is a water-permeable mounting chute means, 2 is a slot, 3 is an insertable filter wall, 4 is a fixing pile, 5 is a side baffle, 6 is a fixing ring, 7 is a handle, 8 is a coarse grid intercepting mesh, 9 is a narrow groove, 10 is a bottom baffle, 11 is the microorganism-coupled activated carbon carrier, 12 is an iron wire mesh, 13 is an reinforcing cross, 14 is a hinge, 15 is a stainless steel border, 16 is a stainless steel closure cover, 17 is a snap, and 18 is a farmland drainage ditch.

### DETAILED DESCRIPTION OF EMBODIMENTS

Referring to the drawings, provided is a device with microorganism-coupled activated carbon for removing agricultural chemicals in farmland drainage water, comprising a water-permeable mounting chute means 1, a coarse grid intercepting mesh 8, an insertable filter wall 3 and fixing piles 4; the water-permeable mounting chute means 1 is provided with a slot 2 and a narrow groove 9, is closed at the bottom and the two sides parallel to the length direction of the farmland ditch by a bottom baffle 10 and side baffles 5, respectively, and is fixed to the farmland drainage ditch 18 by the fixing piles 4; the insertable filter wall 3 is inserted into the slot 2; and the coarse grid intercepting mesh 8 is inserted into the narrow groove 9.

Preferably, the bottom baffle 10 and the side baffle 5 are made of PVC plastics. The water-permeable mounting chute means 1 is made from angle steels and PVC plastic plates. The water-permeable mounting chute means 1 is rectangular in shape as a whole. The water-permeable mounting chute means 1 possesses one angle steel on each of the four edges of the frame parallel to the drainage ditch, and each of the angle steels is cut at the front and rear end to form narrow grooves, the narrow grooves at the front end of the four angle steels form a set of narrow grooves 9, and the narrow grooves at the rear end of the four angle steels form another set of narrow grooves 9. Each angle steel is cut to form a plurality of a plurality of slots 2, the size of which is determined according to the thickness of the insertable filter wall 3. The bottom of the frame and the two sides of the water-permeable mounting chute means 1 parallel to the length direction of the farmland ditch are closed by one bottom baffle 10 and two side baffles 5, respectively, and the other three sides of the water-permeable mounting chute means 1 are in an open state. The water-permeable mounting chute means 1 is fixed to the farmland drainage ditch 18 by the fixing piles 4.

The coarse grid intercepting mesh 8 is made of steel bars and a steel mesh, and the density of the steel mesh is preferably 4.5 kg/m². The coarse grid intercepting mesh 8 is inserted into the narrow grooves 9 at the front or rear end of the water-permeable mounting chute means 1 depending on the direction of water flow, to prevent relatively large suspended solids, crop straw and the like from directly entering and thereby blocking the device.

The insertable filter wall 3 has an open-type top portion and includes stainless steel borders 15 and iron wire meshes 12. The two sides of the insertable filter wall 3 parallel to the length direction of the farmland ditch are made from the stainless steel borders 15, and the two sides of the insertable filter wall 3 perpendicular to the length direction of the farmland ditch are made from the iron wire meshes 12. The top of one of the stainless steel borders 15 is installed with a hinge 14, by which hinge the one of the stainless steel borders 15 is joined to a stainless steel closure cover 16, and the top of another stainless steel border 15 is installed with a snap 17 to lock the stainless steel closure cover 16 when the insertable filter wall 3 is closed. Each of the iron wire meshes is provided with one reinforcing cross 13, through which the iron wire meshes 12 and the stainless steel borders 15 are fixed tightly to ensure the steadiness of the insertable filter wall 3. The stainless steel closure cover 16 is installed with two handles 7 so as to facilitate insertion of the insertable filter walls 3 into the water-permeable mounting chute means 1 and removal of the insertable filter walls from the water-permeable mounting chute means 1.

The insertable filter wall 3 is filled with the microorganism-coupled activated carbon carrier 11, which is filled into the insertable filter wall 3, and the activated carbon has a particle size larger than the mesh size of the iron wire meshes 12.

The microorganism-coupled activated carbon carrier 11 is prepared by steps of: firstly producing indigenous agricultural chemical-degrading bacteria in farmland through domestication and screening, seeding the agricultural chemical-degrading bacteria in a liquid medium for large scale cultivation, feeding the activated carbon particles after activation into the bacterial solution for co-cultivation with the agricultural chemical-degrading bacteria, thereby obtaining the microorganism-coupled activated carbon carrier 11.

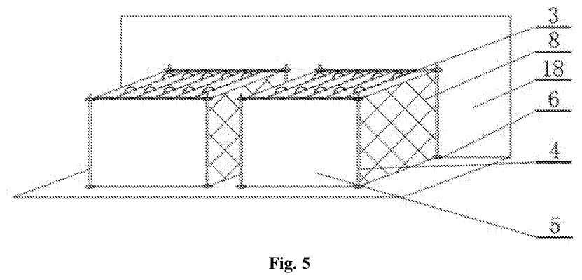

When the device with microorganism-coupled activated carbon for removing agricultural chemicals in the farmland drainage water is used, the coarse grid intercepting mesh 8 is firstly inserted into the narrow grooves 9 at the front or rear end of the water-permeable mounting chute means 1 depending on the direction of water flow, and then a plurality of the insertable filter walls 3 are inserted into the slots 2 of the water-permeable mounting chute means 1, respectively, wherein the inserted number and the interval of the insertable filter walls are determined according to conditions such as the amount of the farmland drainage water and the flow rate of water. As shown in FIG. 5, several devices of the invention are disposed in the farmland drainage ditch 18. When water body flows through the device of the invention, large particle impurities are firstly blocked by the coarse grid intercepting mesh 8, and when water body sequentially passes through several layers of the insertable filter walls 3, the agricultural chemicals in the water body are adsorbed and degraded efficiently by microorganism-coupled activated carbon carrier 11 filled inside the insertable filter walls. After the devices run for a period of time, the insertable filter walls 3 are drawn out from the water-permeable mounting chute means 1, the stainless steel closure cover 16 is opened and the inner microorganism-coupled activated carbon carrier 11 is poured out from the top and replaced. In the case where the amount of the farmland drainage water is large during rain or flooding, the coarse grid intercepting mesh 8 and the insertable filter walls 3 are removed, or the inserted number of the insertable filter walls 3 is reduced, in order to avoid blockage of the ditch and to ensure a smooth flow of water in the farmland ditch.

The water-permeable mounting chute means is made by welding angle steels into a rectangular frame according to the size of the drainage ditch. The four angle steels of the frame parallel to the drainage ditch are cut at the front and rear ends to form narrow grooves 9, and are cut in the middle to form a plurality of slots 2. The size of the slots 2 is determined according to the thickness of the insertable filter walls 3. The bottom and the two sides with slots of the frame are closed by one bottom baffle 10 of PVC plastics and two side baffles 5 of PVC plastics, respectively, and the other three sides are open, thereby forming the water-permeable mounting chute means 1. The water-permeable mounting chute means 1 has a fixing ring 6 on the side. After the water-permeable mounting chute means 1 is disposed in the farmland drainage ditch 18, the fixing piles 4 made of wood or iron for the farmland ditch are inserted through the fixing ring 6 into the soil at the bottom of the ditch, such that the water-permeable mounting chute means 1 is fixed to the farmland drainage ditch 18.

The coarse grid intercepting mesh 8 is made of steel bars and a high-density steel mesh, and is inserted into the narrow groove 9 at the front or rear end of the water-permeable mounting chute means according to the direction of the water flow, functioning as a coarse grid to prevent relatively large suspended solids, crop straws and the like from directly entering and thereby blocking the device.

The activated carbon in the microorganism-coupled activated carbon carrier 11 is in a form of particles. The activated carbon needs to be activated prior to being loaded with microorganisms. The activation includes steps of: (1) calcinating the activated carbon at 500° C. for 4 hours prior to rinse with sterile water for 3 times, 15 min for each time; (2) adding the activated carbon particles obtained in step (1) to a solution of 0.1 M ethylenediaminetetraacetic acid and immersing the particles in the solution at 25° C. for 24 hours for chelation modification, and removing the activated carbon particles from the ethylenediaminetetraacetic acid solution after immersion; (3) immersing the activated carbon modified in step (2) in a solution of 30% sodium hydroxide for 12 hours and removing the activated carbon after immersion; (4) immersing the activated carbon alkali-washed in step (3) in a solution of 30% hydrochloric acid for 12 hours and removing the activated carbon after immersion; (5) rinsing the activated carbon with sterile water for 5-6 times, 15 min for each time, followed by drying at 100° C. until dryness.

The microorganism in the microorganism-coupled activated carbon carrier 11 is a chlorpyrifos-degrading strain, Sphingomonas sp. Dsp-2, obtained from the farmland soil by domestication and screening. The Sphingomonas sp. Dsp-2 strain is cultivated on a large scale in the LB medium (containing 10 g/L of tryptone, 5 g/L of the yeast extract, and 10 g/L of sodium chloride; pH 7.0) on a shaker at a rotation rate of 200 rpm at a cultivation temperature of 30° C. The absorbance OD600 is measured with a spectrophotometer for detecting the growth of the degrading bacteria. Once the growth of the degrading bacteria reaches the plateau phase, the activated carbon after activation is added to the culture system for 24 hours co-cultivation. Sphingomonas sp. Dsp-2 bacteria enter the micro-pores inside the activated carbon and adhere closely to the surface of the micro-pores, thus obtaining the chlorpyrifos-degrading bacteria-coupled activated carbon carrier 11.

The implementing procedures of the invention are described in detail below by reference to the specific examples, which are intended to allow those of ordinary skill in the art to further understand the invention, but not to limit the invention in any way.

### EXAMPLES

Provided is a device with microorganism-coupled activated carbon for removing agricultural chemical chlorpyrifos from farmland drainage water, comprising a water-permeable mounting chute means 1, a coarse grid intercepting mesh 8, an insertable filter wall 3 and fixing piles 4; the water-permeable mounting chute means 1 is provided with a slot 2 and a narrow groove 9, is closed at the bottom and the two sides parallel to the length direction of the farmland ditch by a bottom baffle 10 of PVC plastics and side baffles 5 of PVC plastics, respectively, and is fixed to the farmland drainage ditch 18 by the fixing piles 4; the insertable filter wall 3 is inserted into the slot 2; and the coarse grid intercepting mesh 8 is inserted into the narrow groove 9.

The water-permeable mounting chute means 1 has a length of 80 cm, a width of 80 cm and a height of 60 cm, and is formed by welding angle steels. The four angle steels parallel to the drainage ditch are cut at a position that is 2 cm away from the front and rear end to form arrow grooves 9 of 0.8 cm in width, and are cut in the middle at an interval of 15 cm to form slots 2 of 3.5 cm in width, four slots 2 in total being formed by cutting at different positions in the length direction of each of the angle steels. The bottom of the mounting chute means is sealed with a PVC plastic bottom baffle 10 with a length of 80 cm and a width of 80 cm, the two sides having slots 2 of the frame are closed by two PVC plastic side baffles 5, and the other 3 sides are open. Thereby, the water-permeable mounting chute means 1 is formed. The water-permeable mounting chute means 1 is provided with fixing rings 6 of 4 cm in diameter by welding the same at four corners thereof Iron-made fixing piles 4 of about 3.5 cm in diameter pass through the fixing rings 6 to fix the permeable mounting chute means 1 to the bottom of the farmland drainage ditch 18.

The coarse grid intercepting mesh 8 is made by welding steel bars and a steel mesh having a high density (4.5 kg/m²), and has a length of 79.5 cm, a height of 60 cm and a width of 0.5 cm.

The insertable filter wall 3 possesses an openable top, and has a length of 79.5 cm, a height of 60 cm and a width of 3 cm. The insertable filter wall 3 is made by welding a stainless steel border 15 having a width of 3.0 cm and two iron wire meshes 12 (with a mesh size of less than 1.5 cm). A stainless steel closure cover 16 having a length of 79.5 cm and a width of 3 cm is joined to the stainless steel border 15 through a hinge 14. A reinforcing cross 13 is made by welding two steel bars of 79.5 cm in length, 60 cm in width and 0.2 cm in height, and is used to tightly fix the iron wire meshes 12 to the stainless steel border 15. The stainless steel closure cover 16 is installed with two handles 7 to facilitate insertion of the insertable filter wall 3 into the water-permeable mounting chute means, and removal of the insertable filter wall 3 from the water-permeable mounting chute means.

The activated carbon in the microorganism-coupled activated carbon carrier 11 is in a form of particles with a diameter of greater than 1.5 cm. The activated carbon needs to be activated prior to being loaded with microorganisms. The activation includes steps of: (1) calcinating the activated carbon at 500° C. for 4 hours, and rinsing the same with sterile water for 3 times, 15 min for each time; (2) adding the activated carbon particles obtained in step (1) to a solution of 0.1 M ethylenediaminetetraacetic acid and immersing the particles in the solution at 25° C. for 24 hours for chelation modification, and removing the activated carbon particles from the ethylenediaminetetraacetic acid solution without drying after immersion; (3) immersing the activated carbon modified in step (2) with a solution of 30% sodium hydroxide for 12 hours and removing the activated carbon without drying after immersion; (4) immersing the activated carbon alkali-washed in step (3) with a solution of 30% hydrochloric acid for 12 hours and removing the activated carbon without drying after immersion; (5) rinsing the activated carbon with sterile water for 5-6 times, 15 min for each time, followed by drying at 100° C. until dryness. The microorganism in the microorganism-coupled activated carbon carrier 11 is a chlorpyrifos-degrading strain, Sphingomonas sp. Dsp-2, obtained from the farmland soil by domestication and screening. The Sphingomonas sp. Dsp-2 strain is cultivated on a large scale in the LB medium (containing 10 g/L of tryptone, 5 g/L of the yeast extract, and 10 g/L of sodium chloride; pH 7.0) on a shaker at a rotation rate of 200 rpm at a cultivation temperature of 30° C. The absorbance OD600 is measured with a spectrophotometer for detecting the growth of the degrading bacteria. Once the growth of the bacteria reaches the plateau phase, the activated carbon after activation is added to the culture system for 24-hour co-cultivation. Sphingomonas sp. Dsp-2 bacteria enter the micro-pores inside the activated carbon and adhered closely to the surface of the micro-pores, thereby obtaining the chlorpyrifos-degrading bacteria-coupled activated carbon carrier 11.

When the device is used, the coarse grid intercepting mesh 8 is firstly inserted into the narrow grooves 9 at the front or rear end of the water-permeable mounting chute means 1 depending on the direction of the water flow, in order to block large suspended solids, crop straws and the like, and then the insertable filter walls 3 are inserted into the water-permeable mounting chute means 1, the inserted number of which can be adjusted flexibly according to the flow rate of water. As shown in FIG. 5, 2-10 devices are fixed to the farmland drainage ditch. Chlorpyrifos in the farmland drainage water is purified layer by layer when the drainage water flows through a plurality of the insertable filter walls 3 in the device, achieving efficient removal of agricultural chemical residues in water body and water purification. After the device runs for a period of time, the insertable filter walls 3 can be drawn out from the water-permeable mounting chute means 1, the stainless steel closure cover 16 can be opened and the inner microorganism-coupled activated carbon carrier 11 can be poured out from the top and replaced. The recovered microorganism-coupled activated carbon carrier 11, when being treated, can be calcinated at a high temperature of 500° C. for at least 4 hours to eliminate the agricultural chemicals that are adsorbed but not yet degraded.

1. A device with microorganism-coupled activated carbon for removing agricultural chemicals in farmland drainage water, comprising a water-permeable mounting chute means, a coarse grid intercepting mesh, an insertable filter wall and fixing piles; wherein the water-permeable mounting chute means is provided with a slot and a narrow groove, is closed at the bottom and the two sides parallel to the length direction of a farmland drainage ditch by a bottom baffle and side baffles, respectively, and is fixed to the farmland drainage ditch by the fixing piles; the insertable filter wall is inserted into the slot; and the coarse grid intercepting mesh is inserted into the narrow groove.

2. The device with microorganism-coupled activated carbon for removing agricultural chemicals in farmland drainage water according to claim 1, wherein the water-permeable mounting chute means is made from angle steels and PVC plastic plates, is rectangular in shape as a whole, and possesses one angle steel on each of four edges of the frame thereof parallel to the drainage ditch; each of the angle steels is cut at the front and rear ends to form narrow grooves, with the narrow grooves at the front end of the four angle steels forming a set of narrow grooves, and the narrow grooves at the rear end of the four angle steels forming another set of narrow grooves; each of the angle steels is cut to form a plurality of slots with a size determined according to the thickness of the insertable filter wall; the bottom of the frame and the two sides of the water-permeable mounting chute means parallel to length direction of the farmland ditch are closed by one bottom baffle and two side baffles, respectively, and the other three sides of the water-permeable mounting chute means are in an open state; and the water-permeable mounting chute means is fixed to the farmland drainage ditch by the fixing piles.

3. The device with microorganism-coupled activated carbon for removing agricultural chemicals in farmland drainage water according to claim 1, wherein the coarse grid intercepting mesh is made of steel bars and a high-density steel mesh, and is inserted into the narrow grooves at the front or rear end of the water-permeable mounting chute means depending on the direction of water flow, to prevent large suspended solids, crop straw and the like from directly entering and thereby blocking the device.

4. The device with microorganism-coupled activated carbon for removing agricultural chemicals in farmland drainage water according to claim 1, wherein the two sides of the insertable filter wall parallel to the length direction of the farmland ditch are made from stainless steel borders and the two sides of the insertable filter wall perpendicular to the length direction of the farmland ditch are made from iron wire meshes; one of the stainless steel borders is provided with a hinge on the top, by which hinge the one of the stainless steel borders is joined to a stainless steel closure cover, and another stainless steel border is provided on the top with a snap to lock the stainless steel closure cover when the insertable filter wall is closed; each of the iron wire meshes is provided with one reinforcing cross, through which the iron wire meshes and the stainless steel borders are fixed tightly to ensure the steadiness of the insertable filter wall; and the stainless steel closure cover is installed with two handles to facilitate insertion of the insertable filter wall into the water-permeable mounting chute means and removal of the insertable filter wall from the water-permeable mounting chute means.

5. The device with microorganism-coupled activated carbon for removing agricultural chemicals in farmland drainage water according to claim 1, wherein the insertable filter wall is filled with microorganism-coupled activated carbon carrier, which is filled into the insertable filter wall, and the activated carbon has a particle size larger than the mesh size of the iron wire meshes.

6. The device with microorganism-coupled activated carbon for removing agricultural chemicals in farmland drainage water according to claim 5, wherein the microorganism-coupled activated carbon carrier is prepared by steps of: firstly producing indigenous agricultural chemical-degrading bacteria in farmland through domestication and screening, seeding the agricultural chemical-degrading bacteria in a liquid medium for large scale cultivation, and feeding the activated carbon particles after activation into the bacterial solution for co-cultivation with the agricultural chemical-degrading bacteria, thereby obtaining the microorganism-coupled activated carbon carrier.

7. The device with microorganism-coupled activated carbon for removing agricultural chemicals in farmland drainage water according to claim 1, wherein when the device is used, the coarse grid intercepting mesh is firstly inserted into the narrow grooves at the front or rear end of the water-permeable mounting chute means depending on the direction of water flow, and then a plurality of insertable filter walls are correspondingly inserted into the slots of the water-permeable mounting chute means, respectively, with an inserted number and interval being determined according to conditions such as the amount of the farmland drainage water and the flow rate of water; when water body passes through the device of the invention, large particle impurities are firstly blocked by the coarse grid, and when the water body passes through several layers of the insertable filter walls sequentially, agricultural chemicals in the water body are adsorbed and degraded by the microorganism-coupled activated carbon carrier filled in the insertable filter walls; after the device runs for a period of time, the insertable filter walls are drawn out from the water-permeable mounting chute means, the stainless steel closure cover is opened and the inner microorganism-coupled activated carbon carrier is poured out from the top and replaced; and when the amount of the farmland drainage water is large during rain or flooding, the coarse grid intercepting mesh and the insertable filter walls are removed or the inserted number of the insertable filter walls is reduced, in order to avoid blockage of the ditch and to ensure a smooth flow of water in the farmland ditch.
